(19) United States
(12) Patent Application Publication
(10) Pub. No.: US 2005/0092085 A1
(43) Pub. Date: May 5, 2005

(54) Solid-state gyroscopes and planar three-axis inertial measurement unit

(76) Inventors: Shyu-Mou Chen, Longtan Township (TW); Sheau-Shi Tzuoo, Longtan Township (TW); Chung-Ta Kau, Longtan Township (TW)

Correspondence Address: BIRCH STEWART KOLASCH & BIRCH, PO BOX 747, FALLS CHURCH, VA, 22040-0747, US

(21) Appl. No.: 10/699,868

(22) Filed: Nov. 4, 2003

(51) Int. Cl. G01P 1/04; G01P 9/04; G01P 15/14; G01P 15/18

(52) U.S. Cl. 73/504.14; 73/504.04

(57) ABSTRACT

The present invention relates to a z-axial solid-state gyroscope. Its main configuration is manufactured with a conductive material and includes two sets of a proof mass and two driver bodies suspended between two plates by an elastic beam assembly. Both surfaces of the driver bodies and the proof masses respectively include a number of grooves respectively perpendicular to a first axis and a second axis. The surfaces of the driver bodies and the proof masses and the corresponding stripe electrodes of the plates thereof are respectively formed a driving capacitors and a sensing capacitors. The driving capacitor drives the proof masses to vibrate in the opposite direction along the first axis. If a z-axial angular velocity input, a Coriolis force makes the two masses vibrate in the opposite direction along the second axis. If a second axial acceleration input, a specific force makes the two masses move in the same direction along the second axis. Both inertial forces make the sensing capacitances change. Two z-axial solid-state gyroscopes and two in-plane axial gyroscopes can be designed on a single chip to form a complete three-axis inertial measurement unit.

### BACKGROUND OF THE INVENTION

1. Field of the Invention

The present invention relates to solid-state gyroscopes and a three-axis inertial measurement unit, which are in particular manufactured by a micro-mechanical technique, and can sense three axes angular velocities and three axes accelerations simultaneously.

2. The Related Art

The sensing axis of angular velocity for most of conventional gyroscopes manufactured by a micro-mechanical technique is parallel to the structure surface thereof. Furthermore, in case of needing to concurrently sense three axial angular velocities and accelerations, if the sensing axis of angular velocity is perpendicular to the structure surface thereof, the gyroscopes and accelerometers can be built on a single chip to measure three axial angular velocities and accelerations, and the cost and size thereof can be thus largely reduced. Therefore the other types of gyroscopes are born.

### SUMMARY OF THE INVENTION

FIG. 1 shows a configuration of a conventional solid-state gyroscope, comprising two proof masses 3 and two comb drivers 31, 32 corresponding to each proof mass. Its sensing axis is perpendicular to the structure surface thereof. The proof masses 3 and the comb drivers 31, 32 are connected to an anchor 60 fixed on a substrate 71 by a number of elastic beams 6, 61, 62. The proof masses 3 have a number of regularly arranged holes 3h. The surface of the substrate 71 there under includes a number of pairs of stripe electrodes 91, 92 perpendicular to a sensing axis (x-axis) and respectively connected to bond pads 9p, 9n. The distance between corresponding points of the holes 3h along the x-axis is the same as that of the pairs of stripe electrodes 91, 92. The pairs of stripe electrodes 91, 92 and the surface of the proof mass 3 are formed two sensing capacitors c9p, c9n. The proof masses 3, comb drivers 31, 32 and elastic beams 6, 61, 62 may be formed from metal, doped silicon, silicon, or poly-silicon. The lengths, widths and thickness of the elastic beams 6, 61, 62 are designed to facilitate the two axial compliances parallel to the structure surface thereof.

The two outer comb drivers 31 are respectively excited with a DC bias and an AC voltage at the mechanical resonant frequency thereof to cause the two proof masses 3 to vibrate in the opposite direction along the y-axis. The two inner comb drivers 32 are respectively excited with a DC bias and a high frequency AC voltage of opposite phase, and are mainly used to sense the driven amplitudes of the proof masses 3 and feedback the signals thereof for controlling the driven amplitudes. If a z-axial angular velocity input, a Coriolis force makes the two proof masses 3 vibrate in the opposite direction along the x-axis and causes a change in the capacitances of the sensing capacitors c9p, c9n. The sensing capacitors c9p, c9n are respectively excited with a DC bias and a high frequency AC voltage of opposite phase. The current sensed from the output node GN is proportional to the differential displacement of the two proof masses 3.

There is another type of sensing capacitor, a comb capacitor (not shown in FIG. 1), being able to be used to sense the movements of the proof masses 3 along the x-axis. When the proof masses 3 move along the x-axis, the change in the distance of the capacitors results in the change in the capacitance thereof, which can be used to sense the displacements of the proof masses 3.

Although the second type of the conventional solid-state gyroscope can sense the angular velocity perpendicular to the structure surface thereof, it is more difficult to manufacture a practical electrostatic comb driver or a comb sensing capacitor. The reason is that they have two deep and spaced narrow vertical surfaces, which are suitable for being manufactured by dissolved wafer process, surface micromachining, and dry etching. The aspect ratio decreases with the increase in depth. The sensitivity thereof is also limited. The bulk micromachining techniques with larger structures are not suitable here.

The improvements of the present invention comprise: the drivers and the sensors using a structure of stripe capacitors with an edge effect; the manufacturing process being simple; no need to manufacture two deep and spaced narrow vertical surfaces; no special manufacturing process requirement of high aspect ratio; and suitable for multiple fabrication techniques.

In summary, the present invention discloses: (1) a z-axial solid-state gyroscope being able to sense an angular velocity perpendicular to the structure surface thereof and to sense an axial acceleration parallel to the structure surface thereof; (2) a solid-state gyroscope being able to sense an angular velocity parallel to the structure surface and to sense an axial acceleration perpendicular to the structure surface thereof; (3) two z-axial solid-state gyroscopes and two solid-state gyroscopes with sensing axes parallel to the structure surface thereof being designed on a single chip to form a functionally complete planar inertial measurement unit that can be concurrently manufactured in one manufacturing process, and the size and the manufacturing and assembling cost thereof can be largely reduced.

### BRIEF DESCRIPTION OF THE DRAWINGS

The objects, effectiveness and configurations of the present invention will be more definitely understood after reading the detailed description of the preferred embodiment thereof with reference to the accompanying drawings.

FIG. 1 is a schematic view of a configuration of a conventional solid-state gyroscope, which can sense an angular velocity perpendicular to the structure surface thereof.

FIG. 2 is a schematic view of a configuration of a z-axial solid-state gyroscope in accordance with a preferred embodiment of the present invention, in which FIG. 2a shows a top view of the main configuration thereof and FIG. 2b shows a schematic view of stripe electrodes of driving capacitors and sensing capacitors on a surface of a glass plate.

FIG. 3 is a cross-sectional schematic view of a configuration of the stripe electrodes of the driving capacitor and the sensing capacitor.

FIGS. 4 and 5 are schematic views of the configurations of the z-axial solid-state gyroscopes in accordance with another two preferred embodiments of the present invention.

FIG. 6 is a schematic view of a configuration of a z-axial solid-state gyroscope, which is manufactured with a (110) silicon chip by bulk micromachining technique, in accordance with a preferred embodiment of the present invention, in which FIG. 6a shows a top view of the main configuration thereof and FIG. 6b shows a schematic view of stripe electrodes of driving capacitors and sensing capacitors on a surface of a glass plate.

FIG. 7 is a schematic view of a configuration of an x-axial solid-state gyroscope, the sensing axis thereof parallel to the structure surface thereof, in accordance with a preferred embodiment of the present invention, in which FIG. 7a shows a top view of the main configuration thereof and FIG. 7b shows a schematic view of stripe electrodes of driving capacitors and sensing capacitors on a surface of a glass plate.

FIG. 8 is a schematic view of a configuration of a planar three-axis inertial measurement unit constructed by four solid-state gyroscopes, in which FIG. 8a shows a configuration of a rectangular contour or a square contour thereof and FIG. 8b shows a configuration of a parallelogram contour, manufactured with a (110) silicon chip by bulk micromachining technique.

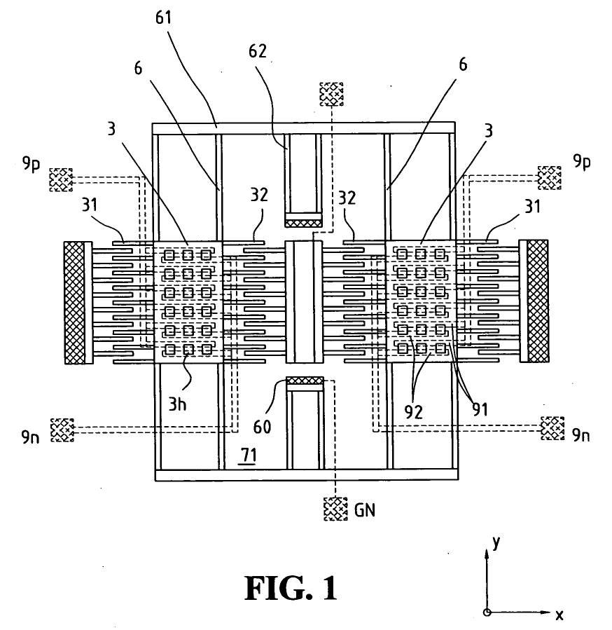

### DETAILED DESCRIPTION OF THE PREFERRED EMBODIMENT

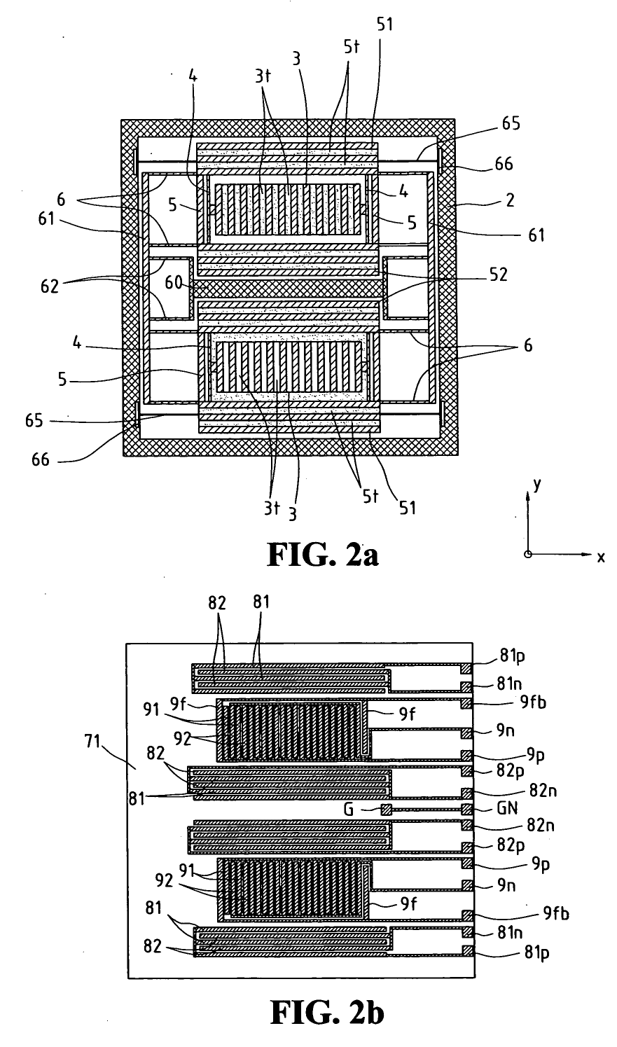

Referring to FIG. 2a, which shows a schematic view of a configuration of a z-axial solid-state gyroscope of a preferred embodiment in accordance with the present invention, the configuration is manufactured with a conductive material and comprises an outer frame 2 and a central anchor 60. The interior of the outer frame 2 has two sets of a proof mass 3 and two driver bodies 51, 52. Each proof mass 3 is respectively connected to the corresponding two driver bodies 51, 52 thereof by at least one sensing elastic beam 4. Two connection beams 5 connect the two driver bodies 51, 52 to each other. Each proof mass 3 and the corresponding driver bodies 51, 52 thereof are respectively connected to a common connection beams 61 by a number of driving elastic beams 6. The common connection beams 61 are connected to a common elastic beams 62 fixed at the central anchor 60. Each proof mass 3 and the corresponding driver bodies 51, 52 thereof are also additionally suspended to the outer frame 2 by a number of elastic beams 65, 66.

Two glass plates 71, 72 are respectively positioned in front and rear of the main configuration thereof and mounted with the outer frame 2 and the anchor 60 together, so that the other elements are suspended between the two glass plates 71, 72. The sensing beams 4 make the proof masses 3 facilitate move along a specially designated direction (defined as x-axis) parallel to the surfaces of the glass plates 71, 72. The driving elastic beams 6, the common elastic beams 62, and the elastic beams 65, 66 make the proof masses 3 and the driver bodies 51, 52 facilitate move along another specially designated direction (defined as y-axis) parallel to the surfaces of the glass plates 71, 72. Both surfaces of the proof masses 3 respectively have a number of grooves 3t perpendicular to the x-axis. Both surfaces of the driver bodies 51, 52 respectively have a number of grooves 5t perpendicular to the y-axis.

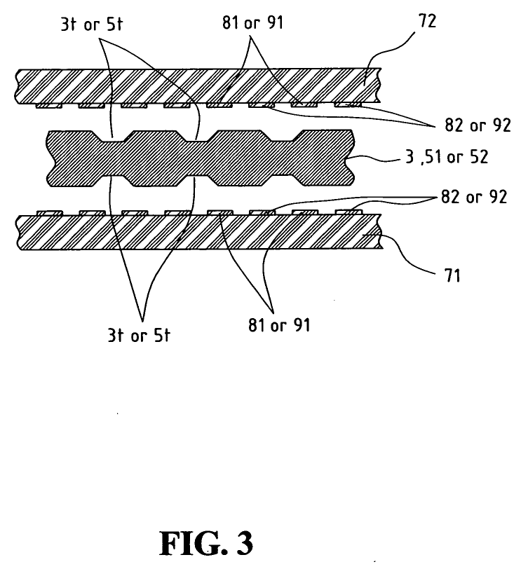

The surface of each glass plate facing the silicon chip and corresponding to each driver body 51 includes two sets of interposed stripe electrodes 81, 82 parallel to the grooves 5t, which are respectively connected to a bond pads 81p, 81n (see FIG. 2b). The relative positions of the grooves 5t on the surface of the driver bodies 51 and the corresponding stripe electrodes 81, 82 thereof are shown in FIG. 3. Each surface of each driver body 51 and the corresponding stripe electrodes 81, 82 thereof respectively are formed two sets of driving capacitors c81p, c81n. In similar, the surface of each glass plate facing the silicon chip and corresponding to each driver body 52 include another two sets of interposed stripe electrodes 81, 82 parallel to the grooves 5t, which are respectively connected to a bond pads 82p, 82n. Another two sets of driving capacitors c82p, c82n are formed.

The surface of each glass plate facing the silicon chip and corresponding to the grooves 3t on the surface of each proof mass 3 thereof also include two sets of interposed stripe electrodes 91, 92 parallel to the grooves 3t, which are respectively connected to a bond pads 9p, 9n. Each surface of each proof mass 3 and the corresponding stripe electrodes 91, 92 thereof are formed two sets of sensing capacitors c9p, c9n.

The outer driving capacitors c81p, c81n are respectively excited with a DC bias and an AC voltage of opposite phase at the mechanical resonant frequency thereof to cause the two proof masses 3 to vibrate in the opposite direction along the y-axis. The inner driving capacitors c82p, c82n are respectively excited with a DC bias and an high frequency AC voltage of opposite phase thereof, and are mainly used to sense the driven amplitude of the proof masses 3 and feedback the signal thereof for controlling the driven amplitude.

If a z-axial angular velocity input, a Coriolis force makes the two proof masses 3 vibrate in the opposite direction along the x-axis. If an x-axial acceleration input, a specific force makes the two proof masses 3 move in same direction along the x-axis. Both inertial forces make the areas of the stripe capacitors change and thus make the capacitances of the sensing capacitors c9p, c9n change.

The sensing capacitors c9p, c9n are respectively excited with a DC bias and a high frequency AC voltage of opposite phase. The current sensed from the output node GN is proportional to the differential displacement of the two proof masses 3. The signals induced by an angular velocity and acceleration is respectively an AC signal and a low frequency or DC signal, which can be separated into a z-axial angular velocity and an x-axial acceleration signal by a signal processing technique. A part of the stripe electrodes 91, 92 of the sensing capacitors c9p, c9n can be isolated as a feedback electrode 9f (see FIG. 2b) for the rebalancing of the Coriolis force.

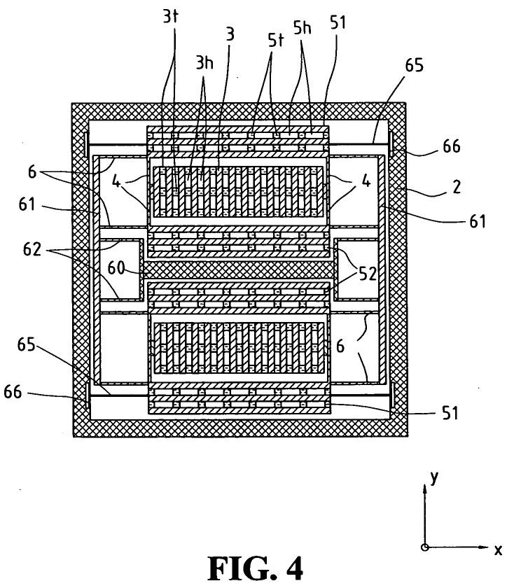

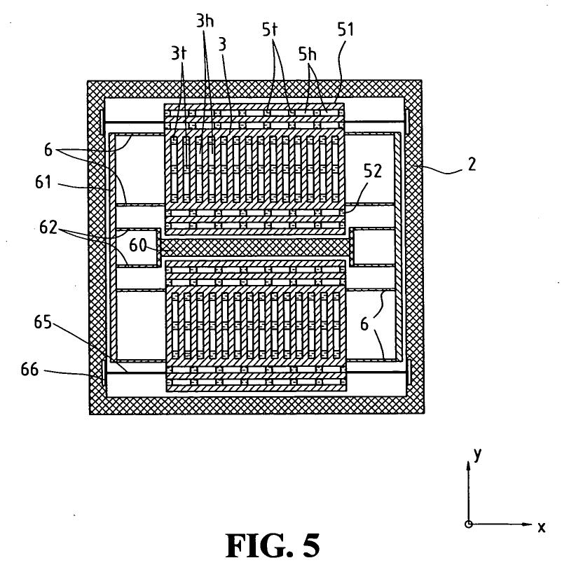

There are many different types of the structure shown in FIGS. 4 and 5. The grooves 3t, 5t on the surfaces of the proof masses 3 and the driver bodies 51, 52 are further etched a plurality of deep holes or through holes 3h, 5h to lessen the burden of the drivers and thus promote the driving performance thereof. In addition, as shown in FIG. 4, the connection beams 5 are deleted but the sensing beams 4 still connect to the two driver bodies 51, 52. Referring to FIG. 5, the sensing beams 4 and the connection beams 5 are deleted, the proof masses 3 and the two driver bodies 51, 52 are directly connected together, the roles of the sensing beams 4 are instead of the common connection beams 61.

The configuration of the present invention can be manufactured by dissolved wafer process, surface micromachining, dry etching, LIGA, and bulk micromachining etc. There has no need to fabricate two deep and spaced narrow vertical surfaces same as those of a conventional comb structure, i.e., no special manufacturing process requirement of high aspect ratio.

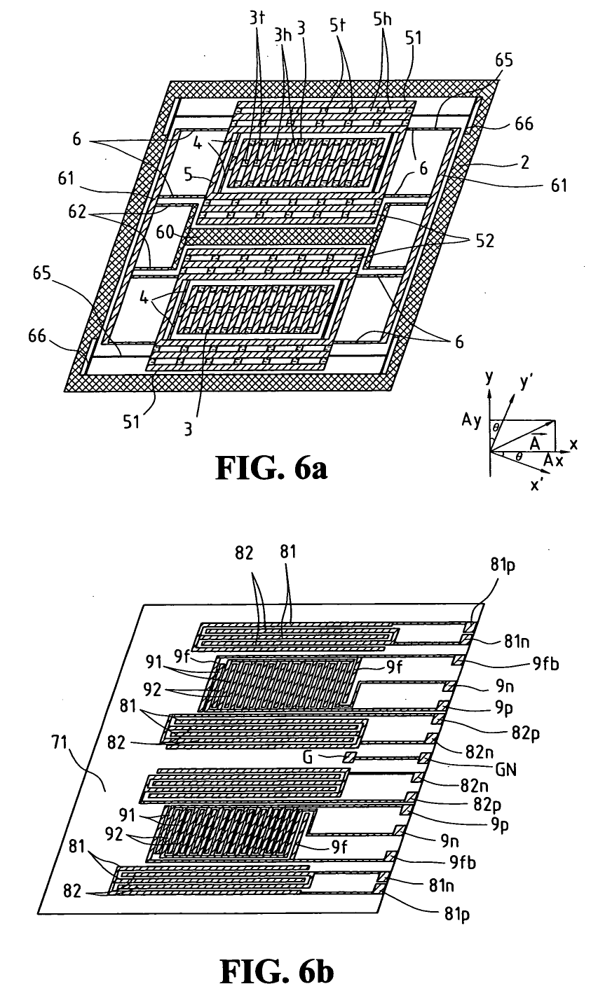

As shown in FIG. 6, the configuration of the present invention is manufactured with a (110) silicon chip by bulk micromachining technique. Due to the non-isotropic wet etching characteristic, the shapes of the device and most elements thereof are parallelogram, the included angle of any two sides being 109.48° or 70.52°. Except shapes, all of the elements and the functions thereof are the same as those of FIG. 4. The (110) silicon chip has the advantages of perpendicularly deep-etching and automatically stop-etching, so the fabrications of the driving beams 6 and the sensing beams 4 are more simple. The widths of the driving beams 6 and the sensing beams 4 and thus the driving and the sensing resonant frequencies thereof can be precisely controlled. Therefore the yield rate of and the sensing performance thereof can be promoted. Because the driving beams 6 and the sensing beams 4 are not orthogonal but 109.48° or 70.52°, the effective Coriolis force is reduced to sin(109.48°) or sin(70.52°) times of its original value, that is 0.94 times. That means the sensitivity being reduced to 0.94 times of its original value.

A new coordinate system (x′, y′, z) is defined by rotating an original coordinate system (x, y, z) an angle θ, 19.48°, about z-axis. If the driving beams 6 are parallel to the x-axis, the sensing beams 4 are parallel to the y′-axis. Therefore the driving direction is in the y-axis and the sensing capacitors c9p, c9n can sense a z-axial angular velocity Wz and an x′-axial acceleration Ax′.

The above two z-axial solid-state gyroscopes and two in-plane axial gyroscopes can be designed on a single chip to form a functionally complete planar inertial measurement unit having functions of three-axial gyroscopes and three-axial accelerometers.

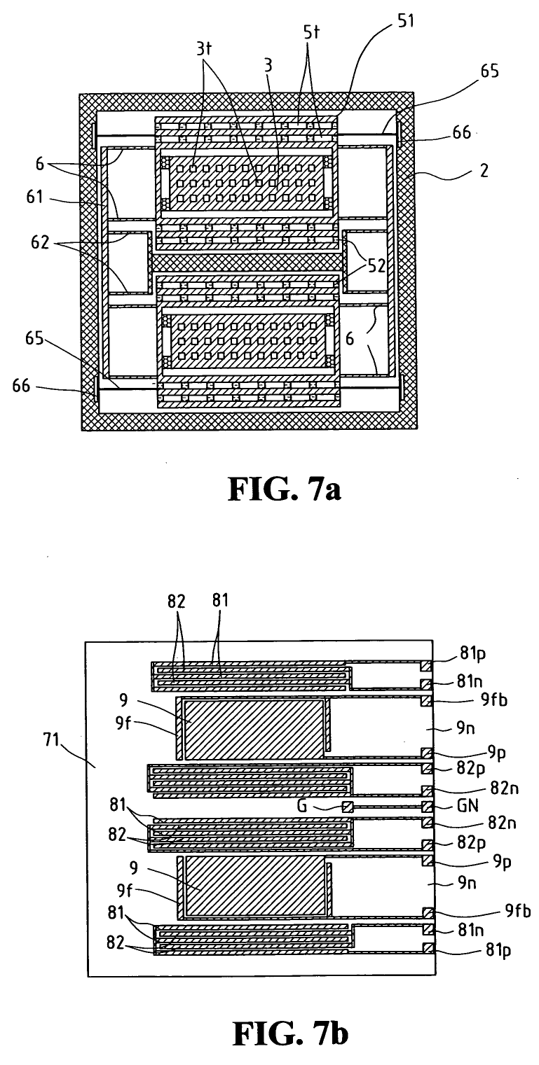

FIG. 7 shows a schematic view of an x-axial solid-state gyroscope in accordance with the present invention, the sensing axis thereof being parallel to its structure surface. FIG. 7a is a top view of the configuration thereof. FIG. 7b shows a schematic view of interposed stripe electrodes 81, 82 of the driving capacitors and electrodes 9 of the sensing capacitors on the surface of a glass plate 71. The configuration of the x-axial solid-state gyroscope in FIG. 7 is substantially same as that of the z-axial solid-state gyroscope in FIG. 2. The major differences between both gyroscopes are: (1) the sensing beams 4 of the x-axial solid-state gyroscope making the proof masses 3 facilitate move along the z-axis, but along the x-axis for the z-axial solid-state gyroscope in FIG. 2; and (2) each sensing electrode on each glass plate corresponding to each proof mass 3 for the x-axial solid-state gyroscope being a single electrode 9, but two sets of interposed stripe electrodes 91, 92 for the z-axial solid-state gyroscope.

To assemble a planar three-axis inertial measurement unit, a y-axis solid-state gyroscope is required except the above x-axial and z-axial gyroscopes, which configuration is the same as the x-axial solid-state gyroscope but rotates an angle about the z-axis.

Four solid-state gyroscopes are assembled to form a planar three-axis inertial measurement unit. The axial arrangements of the driving axis, the sensing axis, the angular velocity input axis, and the acceleration input axis for various gyroscopes are summarized in Table 1 in case of the square or rectangular structure.

TABLE 1
The axial arrangements for various gyroscopes in case of the
square or the rectangular structure.

| Gyroscope | | | Angular velocity | Acceleration |
|---|---|---|---|---|
| No. | Driving axis | Sensing axis | input axis | input axis |
| G1 | Dy | Dz | Wx | Az |
| G2 | Dx | Dz | Wy | Az |
| G3 | Dy | Dx | Wz | Ax |
| G4 | Dx | Dy | Wz | Ay |

From Table 1, there are two sets of output signals of z-axial angular velocity and acceleration.

If a planar three-axis inertial measurement unit is assembled with a z-axial solid-state gyroscope and two in-plane axial solid-state gyroscopes, there are two sets of z-component acceleration signals, Az, but lack of a set of acceleration signal in in-plane axial component. For example if gyroscope G4 is deleted, there is lack of a y-component acceleration, Ay. If gyroscope G3 is deleted, there is lack of an x-component acceleration, Ax. To supplement the signal of the x-component or y-component acceleration, an x-axial or y-axial accelerometer needs to be added.

If a planar three-axis inertial measurement unit is manufactured with a (110) silicon chip by bulk micromachining technique, the axial arrangements of the driving axis, the sensing axis, the angular velocity input axis, and the acceleration input axis for various gyroscopes are summarized in Table 2.

TABLE 2
The axial arrangements for various gyroscopes in case of
the parallelogram structure.

| Gyroscope | | | Angular velocity | Acceleration |
|---|---|---|---|---|
| No. | Driving axis | Sensing axis | input axis | input axis |
| G1 | Dy | Dz | Wx | Az |
| G2 | Dx′ | Dz | Wy′ | Az |
| G3 | Dy | Dx′ | Wz | Ax′ |
| G4 | Dx′ | Dy | Wz | Ay |

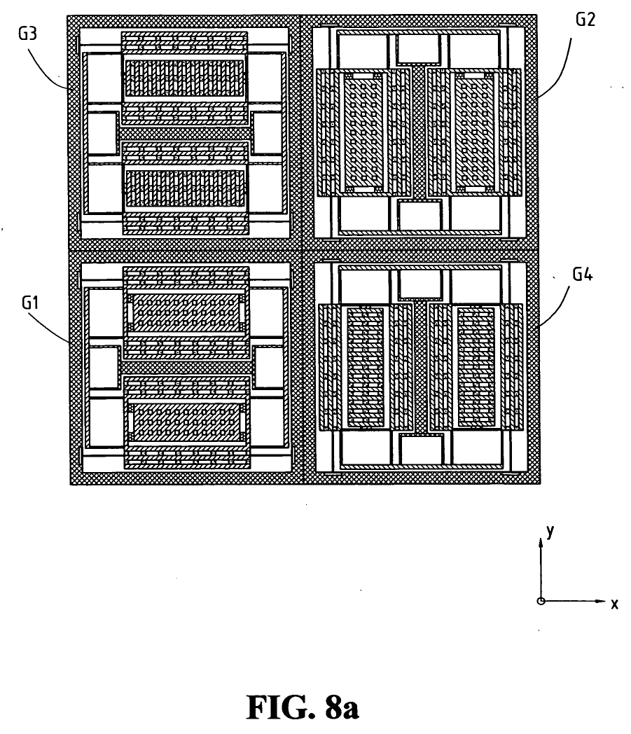

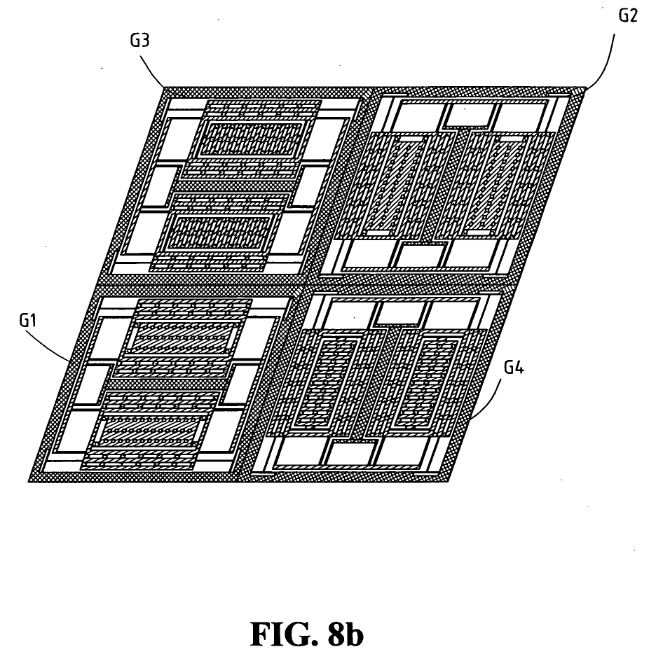

FIG. 8a shows a schematic view of a planar three-axis inertial measurement unit constructed by four solid-state gyroscopes in accordance with the present invention, wherein the axial arrangements of the driving axis, the sensing axis, the angular velocity input axis and the acceleration input axis for various gyroscopes is the same as that listed in Table 1.

FIG. 8b shows a schematic view of a planar three-axis inertial measurement unit constructed by four solid-state gyroscopes, being manufactured with a (110) silicon chip by bulk micromachining technique, in accordance with the present invention, wherein the axial arrangements of the driving axis, the sensing axis, the angular velocity input axis and the acceleration input axis for various gyroscopes is the same as that listed in Table 2.

For a planar three-axis inertial measurement unit manufactured with a (110) silicon chip by bulk micromachining technique, the finally obtained signals include three angular velocity components Wx, Wy′, Wz and three acceleration components Ax′, Ay, Az. Due to the x-axis and the y′-axis, and the x′-axis and the y-axis being non-orthogonal, (Wx, Wy′) and (Ax′, Ay) need to be transferred to an orthogonal coordinate system (x, y, z) or (x′, y′, z′). From the relationship of the coordinate systems (x, y, z) and (x′, y′, z′) shown in FIG. 6b, the transformation formula thereof are the following:
W_{y}=(−Wₓ sin θ+W_{y′})/cos θ,
Aₓ=(A_{x′}+A_{y} sin θ)/cos θ.

The output signals of the above planar three-axis inertial measurement unit of the present invention include three axial angular velocity components and three axial acceleration components. If less component signals are needed, the configurations thereof can be suitably simplified.

The above description is only for illustrating the preferred embodiments of the present invention, and not for giving any limitation to the scope of the present invention. It will be apparent to those skilled in this art that all equivalent modifications and changes shall fall within the scope of the appended claims and are intended to form part of this invention.

1. A z-axial solid-state gyroscope, manufactured by a conductive material, two sets of a proof mass and two driver bodies suspended between two parallel plates by an elastic beam assembly so that they can move along a first axis and a second axis parallel to the surface of the plates;
each surface of each driver body being formed a plurality of grooves perpendicular to the first axis, the surface of each plate corresponding to each driver body being formed two sets of driving electrodes, respectively including a number of stripe electrodes perpendicular to the first axis, the two sets of driving stripe electrodes being interposed each other and being formed two sets of driving capacitors with the corresponding surface of the driver body;
each surface of each proof mass being formed a plurality of grooves perpendicular to the second axis, the surface of each plate corresponding to the proof mass being formed two sets of sensing electrodes, respectively including a number of stripe electrodes parallel to the grooves of the proof mass, the two sets of sensing stripe electrodes being interposed each other and being formed two sets of sensing capacitors with the corresponding surface of the proof mass; the capacitances thereof changing with the movement of the proof masses along the second axis;
each driving capacitor being excited with a DC bias and an AC voltage at the mechanical resonant frequency with proper phase thereof;
the displacement and vibration of each proof mass being able to be obtained by sense the change in the capacitances of the corresponding sensing capacitors thereof;
the output signals of each proof mass induced by an angular velocity and an acceleration being respectively a AC signal and a DC signal, which can be separated into an angular velocity signal and an acceleration signal by a signal processing technique.

2. The z-axial solid-state gyroscope as claimed in claim 1, wherein each groove on the surfaces of each proof mass and each driver body are further etched a plurality of deep holes or through holes.

3. The z-axial solid-state gyroscope as claimed in claim 1, wherein the elastic beam assembly comprises:
a number of connection beams, connecting the two driver bodies corresponding to each proof mass;
a number of sensing beams, connecting each proof mass to the corresponding two driver bodies thereof and making the proof masses be able to move along the second axis;
two common connection beams, positioned at both sides of the proof masses;
a number of first elastic beams, connecting the proof masses and the driver bodies to the common connection beams; and
a number of second elastic beams, connecting the common connection beams to a central anchor fixed at the two plates.

4. The z-axial solid-state gyroscope as claimed in claim 1, wherein the elastic beam assembly comprises:
a number of sensing beams, connecting each proof mass to the corresponding two driver bodies thereof and making the proof mass be able to move along the second axis;
two common connection beams, positioned at both sides of the proof masses;
a number of first elastic beams, connecting the proof masses and the driver bodies to the common connection beams; and
a number of second elastic beams, connecting the common connection beams to a central anchor fixed at the two plates.

5. The z-axial solid-state gyroscope as claimed in claim 1, wherein each proof mass is directly connected to the corresponding two driver bodies thereof, and the elastic beam assembly comprises:
two common elastic connection beams, positioned at both sides of the proof masses;
a number of first elastic beams, connecting the proof masses and the driver bodies to the common elastic connection beams; and
a number of second elastic beams, connecting the common elastic connection beams to a central anchor fixed at the two plates.

6. The z-axial solid-state gyroscope as claimed in claim 3, wherein the elastic beam assembly further comprises a number of third and fourth elastic beams connecting the proof masses and the driver bodies to an outer frame fixed at the two plates.

7. The z-axial solid-state gyroscope as claimed in claim 4, wherein the elastic beam assembly further comprises a number of third and fourth elastic beams connecting the proof masses and the driver bodies to an outer frame fixed at the two plates.

8. The z-axial solid-state gyroscope as claimed in claim 5, wherein the elastic beam assembly further comprises a number of third and fourth elastic beams connecting the proof masses and the driver bodies to an outer frame fixed at the two plates.

9. The z-axial solid-state gyroscope as claimed in claim 1, wherein the elastic beam assembly comprises:
two connection beams, connecting the two driver bodies corresponding to each proof mass;
a number of sensing beams, connecting each proof mass to the corresponding two driver bodies thereof and making the proof masses be able to move along the second axis; and
a number of driving elastic beams, connecting the proof masses and the driver bodies to the outer frame fixed at the two plates.

10. The z-axial solid-state gyroscope as claimed in claim 1, wherein the driving capacitors of the two driver bodies corresponding to each proof mass are divided into two parts:
the first part of the driving capacitors being excited with a DC bias and a AC voltage and making the proof mass move along the first axis; and
the second part of the driving capacitors being excited with a DC bias and a high frequency AC voltage to sense the vibration amplitude signal of the proof mass along the first axis and feedback it to the first part of the driving capacitors to control the vibration amplitude of the proof mass along the first axis.

11. The z-axial solid-state gyroscope as claimed in claim 1, wherein each sensing capacitor are partitioned into two parts:
the first part of the sensing capacitors being excited with a DC bias and a high frequency AC voltage to sense the z-axial angular velocity signal and the second axial acceleration signal; and
the second part of the sensing capacitors being to obtain the signal of the angular velocity and generate a feedback signal for rebalancing the vibration of the proof masses due to a Coriolis force, along the second axis.

12. The z-axial solid-state gyroscope as claimed in claim 1, the main configuration thereof being manufactured with a (110) silicon chip by bulk micromachining technique.

13. A solid-state gyroscope, manufactured by a conductive material, two sets of a proof mass and two driver bodies suspended between two parallel plates by an elastic beam assembly so that the proof masses can move along a first axis parallel to the surface of the plates and along a z-axis perpendicular to the surface of the plates;
each surface of each driver body being formed a plurality of grooves perpendicular to the first axis, the surface of each plate corresponding to each driver body being formed two sets of driving electrodes, respectively including a number of stripe electrodes perpendicular to the first axis, the two sets of driving stripe electrodes being interposed each other and being formed two sets of driving capacitors with the corresponding surface of the driver body;
the surface of each plate corresponding to each proof mass being formed a sensing electrode; the sensing electrodes and the surfaces of each proof mass being formed two sensing capacitors, the capacitances thereof changing with the movement of the proof masses along the z-axis;
each driving capacitor being excited with a DC bias and an AC voltage at the mechanical resonant frequency with proper phase thereof;
the displacement and vibration of each proof mass being able to be obtained by sense the change in the capacitances of the corresponding sensing capacitors thereof;
the output signals of each proof mass induced by an angular velocity and an acceleration being respectively a AC signal and a DC signal, which can be separated into an angular velocity signal and an acceleration signal by a signal processing technique.

14. The solid-state gyroscope as claimed in claim 13, wherein the grooves on the surfaces of each proof mass and each driver body are further etched a plurality of deep holes or through holes.

15. The solid-state gyroscope as claimed in claim 13, wherein the elastic beam assembly comprises:
a number of connection beams, connecting the two driver bodies corresponding to each proof mass;
a number of sensing beams, connecting each proof mass to the corresponding two driver bodies thereof and making the proof masses be able to move along the z-axis;
two common connection beams, positioned at both sides of the proof masses;
a number of first elastic beams, connecting the proof masses and the driver bodies to the common connection beams; and
a number of second elastic beams, connecting the common connection beams to a central anchor fixed at the two plates.

16. The solid-state gyroscope as claimed in claim 13, wherein the elastic beam assembly comprises:
a number of sensing beams, connecting each proof mass to the corresponding two driver bodies thereof and making the proof mass be able to move along the z-axis;
two common connection beams, positioned at both sides of the proof masses;
a number of first elastic beams, connecting the proof masses and the driver bodies to the common connection beams; and
a number of second elastic beams, connecting the common connection beams to a central anchor fixed at the two plates.

17. The solid-state gyroscope as claimed in claim 13, wherein each proof mass is directly connected to the corresponding two driver bodies thereof, and the elastic beam assembly comprises:
two common elastic connection beams, positioned at both sides of the proof masses;
a number of first elastic beams, connecting the proof masses and the driver bodies to the common elastic connection beams; and
a number of second elastic beams, connecting the common elastic connection beams to a central anchor fixed at the two plates.

18. The solid-state gyroscope as claimed in claim 15, wherein the elastic beam assembly further comprises a number of third and fourth elastic beams connecting the proof masses and the driver bodies to an outer frame fixed at the two plates.

19. The solid-state gyroscope as claimed in claim 16, wherein the elastic beam assembly further comprises a number of third and fourth elastic beams connecting the proof masses and the driver bodies to an outer frame fixed at the two plates.

20. The solid-state gyroscope as claimed in claim 17, wherein the elastic beam assembly further comprises a number of third and fourth elastic beams connecting the proof masses and the driver bodies to an outer frame fixed at the two plates.

21. The solid-state gyroscope as claimed in claim 13, wherein the elastic beam assembly comprises:
a number of connection beams, connecting the two driver bodies corresponding to each proof mass;
a number of sensing beams, connecting each proof mass to the corresponding two driver bodies thereof and making the proof masses be able to move along the z-axis; and
a number of driving elastic beams, connecting the proof masses and the driver bodies to the outer frame fixed at the two plates.

22. The solid-state gyroscope as claimed in claim 13, wherein the driving capacitors of the two driver bodies corresponding to each proof mass are divided into two parts:
the first part of the driving capacitors being excited with a DC bias and a AC voltage and making the proof mass move along the first axis; and
the second part of the driving capacitors being excited with a DC bias and a high frequency AC voltage to sense the vibration amplitude signal of the proof mass along the first axis and feedback it to the first part of the driving capacitors to control the vibration amplitude of the proof mass along the first axis.

23. The solid-state gyroscope as claimed in claim 13, wherein each sensing capacitor are partitioned into two parts:
the first part of the sensing capacitors being excited with a DC bias and a high frequency AC voltage to sense the second axial angular velocity signal and the z-axial acceleration signal; and
the second part of the sensing capacitors being to obtain the signal of the angular velocity and generate a feedback signal for rebalancing the vibration of the proof masses, due to a Coriolis force, along the second axis.

24. The solid-state gyroscope as claimed in claim 13, the main configuration thereof being manufactured with a (110) silicon chip by bulk micromachining technique.

25. A planar solid-state three-axis inertial measurement unit, manufactured mainly by a conductive material, a number of solid-state inertial sensors installed between two parallel plates;
a first solid-state gyroscope, the angular velocity sensing axis thereof being parallel to the x-axis of the plate surfaces, the configuration thereof comprising: a first and second sets of a proof mass and two driver bodies, a first elastic beam assembly, a first drivers assembly and a first sensors assembly; the first and second sets of proof mass and driver bodies suspended between the two plates by the first elastic beam assembly so that the first and second sets of proof mass and driver bodies can move along the y-axis parallel to the plate surfaces, and the first and second proof masses can also move along the z-axis perpendicular to the plate surfaces; the first drivers assembly driving the first and second sets of proof mass and driver bodies to vibrate in the opposite direction along the y-axis; the first sensors assembly being able to sense the vibration in the opposite direction and the displacement in the same direction of the first and second proof masses along the z-axis, that meaning the x-axial angular velocity and the z-axial acceleration;
a second solid-state gyroscope, the angular velocity sensing axis thereof being parallel to the y′-axis of the plate surfaces, the configuration thereof comprising: a third and fourth sets of a proof mass and two driver bodies, a second elastic beam assembly, a second drivers assembly and a second sensors assembly; the third and fourth sets of proof mass and driver bodies suspended between the two plates by the second elastic beam assembly so that the third and fourth sets of proof mass and driver bodies can move along the x′-axis parallel to the plate surfaces, and the third and fourth proof masses can also move along the z-axis; the second drivers assembly driving the third and fourth sets of proof mass and driver bodies to vibrate in the opposite direction along the x′-axis; the second sensors assembly being able to sense the vibration in the opposite direction and the displacement in the same direction of the third and fourth proof masses along the z-axis, that meaning the y′-axial angular velocity and the z-axial acceleration; the preceding x′, y′, and z axes are orthogonal;
a third solid-state gyroscope, the angular velocity sensing axis thereof, z-axial, being perpendicular to the plate surfaces, the configuration thereof comprising: a fifth and sixth sets of a proof mass and two driver bodies, a third elastic beam assembly, a third drivers assembly and a third sensors assembly; the fifth and sixth sets of proof mass and driver bodies suspended between the two plates by the third elastic beam assembly so that the fifth and sixth sets of proof mass and driver bodies can move along the y-axis parallel to the plate surfaces, and the fifth and sixth proof masses can also move along the x′-axis; the third drivers assembly driving the fifth and sixth sets of proof mass and driver bodies to vibrate in the opposite direction along the y-axis; the third sensors assembly being able to sense the vibration in the opposite direction and the displacement in the same direction of the fifth and sixth proof masses along the x′-axis, that meaning the z-axial angular velocity and the x′-axial acceleration;
one of a fourth solid-state gyroscope and a y-axial solid-state accelerometer; the fourth solid-state gyroscope, which the angular velocity sensing axis thereof, z-axial, is perpendicular to the plate surfaces, the configuration thereof comprising: a seventh and eighth sets of a proof mass and two driver bodies, a fourth elastic beam assembly, a fourth drivers assembly and a fourth sensors assembly; the seventh and eighth sets of proof mass and driver bodies respectively suspended between the two plates by the fourth elastic beam assembly so that the seventh and eighth sets of proof mass and driver bodies can move along the x′-axis parallel to the plate surfaces, and the seventh and eighth proof masses can also move along the y-axis; the fourth drivers assembly driving the seventh and eighth sets of proof mass and driver bodies to vibrate in the opposite direction along the x′-axis; the fourth sensors assembly being able to sense the vibration in the opposite direction and the displacement in the same direction of the seventh and eighth proof masses along the y-axis, that meaning the z-axial angular velocity and the y-axial acceleration;
the configuration of the y-axial solid-state accelerometer comprising: a ninth proof mass, a fifth elastic beam assembly, and a fifth sensors assembly; the ninth proof mass suspended between the two plates by the fifth elastic beam assembly so that the ninth proof mass can move along the y-axis; the fifth sensors assembly being able to sense the y-axial acceleration signal.

26. The planar solid-state three-axis inertial measurement unit as claimed in claim 25, wherein the elastic beam assembly of each gyroscope comprises:
A number of connection beams, connecting the two driver bodies corresponding to each proof mass;
a number of sensing beams, connecting each proof mass to the corresponding two driver bodies thereof;
two common connection beams, positioned at both sides of the proof masses;
a number of first elastic beams, connecting the proof masses and the driver bodies to the common connection beams; and
a number of second elastic beams, connecting the common connection beams to a central anchor fixed at the two plates.

27. The planar solid-state three-axis inertial measurement unit as claimed in claim 25, wherein each proof mass is directly connected to the corresponding two driver bodies thereof, and the elastic beam assembly of each gyroscope comprises:
two common elastic connection beams, positioned at both sides of the proof masses;
a number of first elastic beams, connecting the proof masses and the driver bodies to the common elastic connection beams; and
a number of second elastic beams, connecting the common elastic connection beams to a central anchor fixed at the two plates.

28. The planar solid-state three-axis inertial measurement unit as claimed in claim 26, wherein each elastic beam assembly further comprises a number of third and fourth elastic beams connecting the proof masses and the driver bodies to an outer frame fixed at the two plates.

29. The planar solid-state three-axis inertial measurement unit as claimed in claim 27, wherein each elastic beam assembly further comprises a number of third and fourth elastic beams connecting the proof masses and the driver bodies to an outer frame fixed at the two plates.

30. The planar solid-state three-axis inertial measurement unit as claimed in claim 25, wherein the configuration of each drivers assembly is constructed by the electrodes of the surface of each plate and the corresponding surface of each driver body; each surface of each driver body of the first, second, third and fourth gyroscopes respectively including a number of grooves or stripe holes respectively perpendicular to the y-axis, x′-axis, y-axis and x′-axis; the surface of each plate corresponding to each driver body being formed two sets of driving electrodes, respectively including a number of stripe electrodes parallel to the grooves or stripe holes of the driver body, the two sets of driving stripe electrodes being interposed each other and being formed two sets of driving capacitors with the corresponding surface of the driver body.

31. The planar solid-state three-axis inertial measurement unit as claimed in claim 25, wherein the configurations of the first and second sensors assembly are respectively constructed by each surface of the first and second proof masses, and each surface of the third and fourth proof masses and the electrode of the surface of each plate corresponding to the proof mass.

32. The planar solid-state three-axis inertial measurement unit as claimed in claim 25, wherein the configurations of the third and fourth sensors assembly are respectively constructed by each surface of the fifth and sixth proof masses and each surface of the seventh and eighth proof masses and the electrodes of the surface of each plate corresponding to each proof mass; each surface of the fifth and sixth proof masses including a number of grooves or stripe holes perpendicular to the x′-axis; each surface of the seventh and eight proof masses including a number of grooves or stripe holes perpendicular to the y-axis; the surface of each plate corresponding to each proof mass being formed two sets of sensing electrodes, respectively including a number of stripe electrodes parallel to the grooves or stripe holes of the proof mass, the two sets of sensing stripe electrodes being interposed each other and being formed two sets of sensing capacitors with the corresponding surface of the proof mass.

33. The planar solid-state three-axis inertial measurement unit as claimed in claim 25, wherein the coordinate system (x′, y′, z) is coincided with the coordinate system (x, y, z).

34. The planar solid-state three-axis inertial measurement unit as claimed in claim 25, wherein the coordinate system (x′, y′, z) is obtained by rotating the coordinate system (x, y, z) a specially designated angle about z-axis; the sensed x′-component and y′-component angular velocity and acceleration signals can be transferred to the x-component and y-component angular velocity and acceleration signals.

35. The planar solid-state three-axis inertial measurement unit as claimed in claim 25, the main configuration thereof being manufactured with a (110) silicon chip by bulk micromachining technique.
